(19) United States
(12) Patent Application Publication
(10) Pub. No.: US 2007/0103488 A1
(43) Pub. Date: May 10, 2007

(54) Substituting pattern fills

(75) Inventors: Benjamen E. Ross, Seattle, WA (US); Cynthia D. Wessling, Redmond, WA (US); Cherie A. Ekholm, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/267,019

(22) Filed: Nov. 4, 2005

(51) Int. Cl. G09G 5/00

(52) U.S. Cl. 345/611

(57) ABSTRACT

Lower resolution bitmaps are substituted with higher resolution bitmaps before output. The higher resolution bitmaps are substituted for the lower resolution bitmaps such that the bitmaps are of sufficient resolution and may be anti-aliased to produce a shape that has high resolution for printing and display devices.

### BACKGROUND

Many programs are designed to display documents such that they look the same when they are shown on user displays as when they are output. These WYSIWYG (What You See Is What You Get) applications, however, rarely provide a seamless appearance between the appearance of the documents while they are displayed on the screen and when they are outputted. Sometimes the differences are subtle enough not to notice, but sometimes the differences are very noticeable and may lead to a poor user experience. For example, pixel rounding errors or color balancing errors may significantly affect the final output.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Higher resolution patterns are substituted for lower resolution patterns before a document is output. While a document is shown on a screen, it may include shapes that utilize low resolution patterns that may appear to a user to be of high quality but if output may result in an output of poor quality. Sometime before the document is output, high resolution patterns are substituted for the lower resolution patterns that are contained within the document. The higher resolution patterns may be anti-aliased and may be of sufficient resolution for high resolution output devices.

### BRIEF DESCRIPTION OF THE DRAWINGS

FIG. 1 illustrates an exemplary computing device;

FIG. 2 shows a pattern substitution system; and

FIG. 3 illustrates a process for substituting low resolution patterns with high resolution patterns, in accordance with aspects of the present invention.

### DETAILED DESCRIPTION

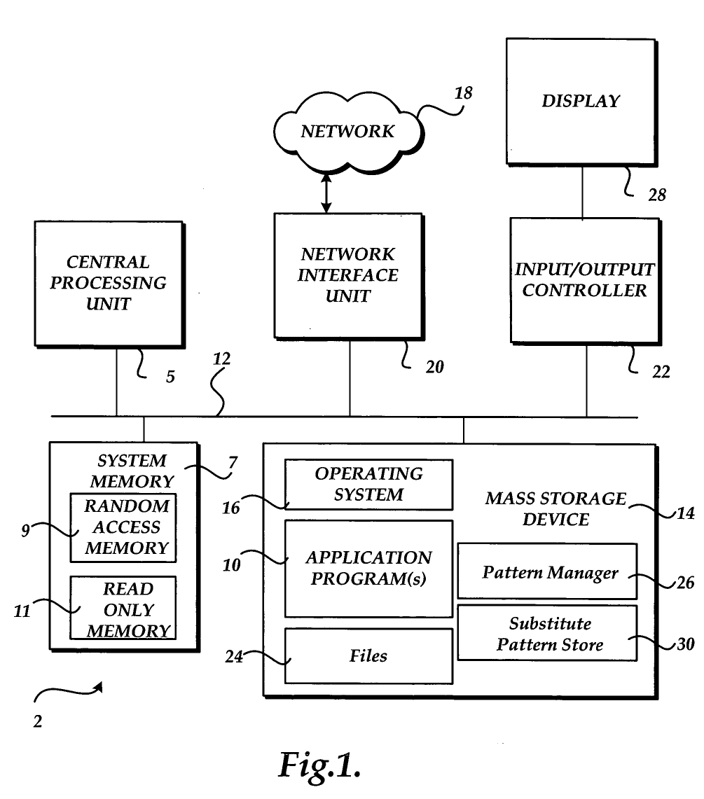

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 2 utilized in various embodiments will be described. The computer architecture shown in FIG. 1 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems. The computer 2 may also include an input/output controller 22 for receiving and processing input from a number of other devices, including a keyboard, mouse, a touch screen, a trackball, electronic stylus, and the like (not shown in FIG. 1). Similarly, an input/output controller 22 may provide output to a display screen 28, a printer, or other type of output device.

As mentioned briefly above, a number of program modules and data files may be stored in the mass storage device 14 and RAM 9 of the computer 2, including an operating system 16 suitable for controlling the operation of a networked personal computer, such as the WINDOWS XP operating system from MICROSOFT CORPORATION of Redmond, Wash. The mass storage device 14 and RAM 9 may also store one or more program modules. In particular, the mass storage device 14 and the RAM 9 may store an application program 10 that is configured to interact with shapes that include low resolution pattern fills. For example, the application program 10 may be a word processing application, a presentation program, a graphics program, a desktop publishing program, and any other type of program that utilizes filled shapes.

Pattern manager 26 is configured to replace lower resolution patterns with higher resolution patterns before any pattern is sent to a higher resolution device, such as a printer or a resolution-independent document format, such as the Portable Document Format (PDF). As will be described in greater detail below, pattern manager 26 substitutes a higher resolution bitmap fill pattern for the lower resolution bitmap fill patterns contained within a document before it is output. In particular, pattern manager 26 checks for any low resolution pattern fills that are contained within a document and for each low resolution pattern fill determines if the system has a higher resolution pattern available in the substitute pattern store 30 that may be substituted for the lower resolution fill. Although substitute pattern store 30 is shown within mass storage device 14, the store may be located in any location that is coupled to computing device 2. For example, substitute pattern store 30 may be located on a server that is coupled to computing device 2. When a high resolution substitute pattern is available, the lower resolution pattern is replaced with the pattern obtained from substitute pattern store 30. Additional details regarding the operation of pattern manager 26 will be provided below.

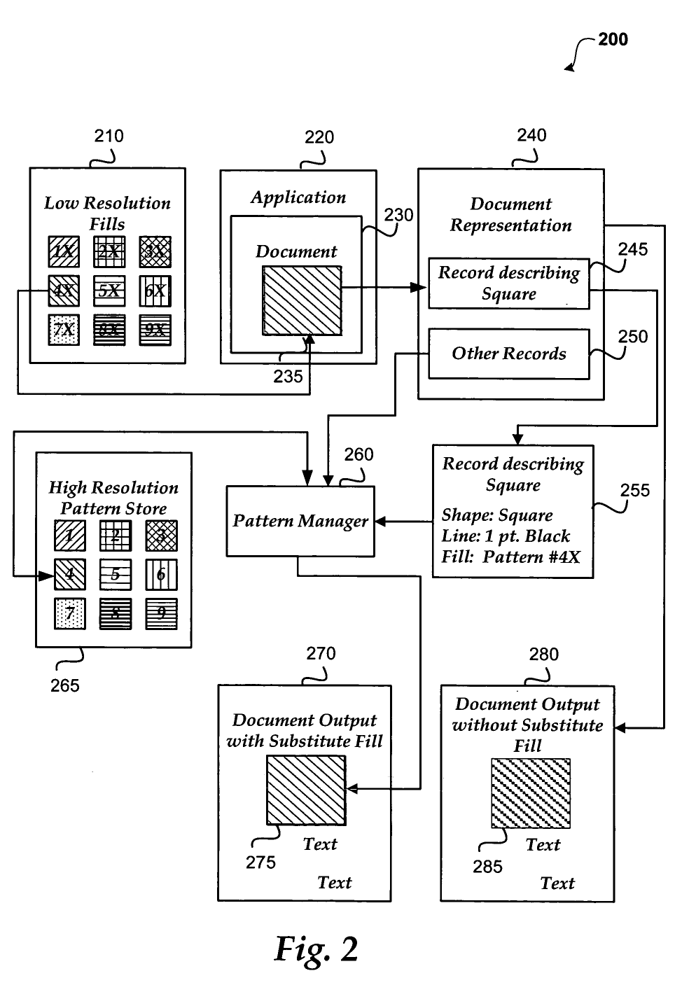

FIG. 2 shows a pattern substitution system 200, in accordance with aspects of the invention. FIG. 2 provides additional details regarding the substitution of lower resolution bitmaps with higher resolution bitmaps. As described briefly above, the pattern manager 260 replaces low resolution patterns, such as the pattern contained within shape 235 with a high resolution pattern that is obtained from the high resolution pattern store 265.

Generally, pattern fills that are native to an application 220 are typically a small, low-resolution bitmap that is repeated to fill a shape. Many times these low-resolution bitmaps are also resolution dependent. In other words, the bitmap is defined to be X pixels across by Y pixels high. As a result of the resolution dependence, when the shape is magnified, shrunk, or output to a device having a different resolution, the resolution dependent bitmap is merely stretched or shrunk to fit the new resolution. This can result in a poor quality output. For example, the bitmap may show jagged edges when output.

Referring to document 230, a square includes a low resolution fill pattern 235. Although the lines shown within pattern 235 may appear to be smooth and very close together on a high resolution device, the lines within pattern 235 will appear jagged and far apart when output to a low resolution output device as shown in square 285.

Many graphic subsystems provide a set of APIs for an application, such as application 220 to call to render 2D graphics, shapes, and text that include a set of fill patterns and other properties for the objects. Typically, the fill patterns are low-resolution, resolution dependent bitmaps (210). As illustrated, fill pattern 4X shown in low resolution pattern store 210 has been used to fill square 235.

A document representation 240 includes information relating to the elements within document 230 such as one or more records describing the square 245 along with any other records 250 that relate to the document. A more detailed record 255 illustrates some exemplary properties that may be included with a shape. The records sometimes contain graphics device interface, such as GDI or GDI+ descriptions of objects contained within the original document. These instructions describe an object, for example a square, and its properties, such as line weight, color, and fill. As shown, record 255 includes the type of shape (square); the size and color of the line of the border of the square (1 pt. Black) and the fill pattern (4X). Many other properties may also be stored.

According to one embodiment, the document representation is a record metafile that is stored in the Enhanced Metafile (EMF) format as defined by the MICROSOFT WINDOWS GDI. The EMF representation is essentially a series of records that describe how the document is rendered to an output. According to one embodiment, the output is to an electronic paper format, such as to the Portable Document Format (PDF).

Prior to sending document to be output, pattern manager 260 substitutes any known low resolution bitmap patterns within document 230 with higher resolution bitmap patterns obtained from high resolution pattern store 265. According to one embodiment, there is a corresponding pattern contained within the high resolution store for each of the low resolution patterns that are stored in store 210. High resolution pattern store 265 is configured to store higher resolution bitmaps as compared to the low resolution bitmaps stored within low resolution store 210. According to one embodiment, the high resolution patterns stored within high resolution pattern stored are of sufficiently high resolution as to be scalable down to any realistically required resolution and still produce the required tiled size—in other words, they are effectively resolution independent bitmaps. For example, if we want our tile size to be ⅛^{th} inch in each direction and our maximum realistic resolution is 2400 DPI, then the high resolution bitmap would be 300 pixels high and wide. In this way, when the shape is grown or shrunk, or the resolution of the display changes, the pattern will still maintain the same proportions.

If the instructions for an object, such as the square, describe a pattern fill, instead of directly calling GDI/GDI+ to render the fill portion of the object, pattern manager 260 instead accesses the high resolution pattern store 265 and substitutes the corresponding high resolution pattern fill and then calls the graphics routine to output the document. As illustrated, output document 270 includes square 275 that includes a high resolution pattern (4) as obtained from pattern store 265 is substituted for the low resolution pattern fill (4X) obtained from the low resolution fills 210. In contrast, output document 280 shows document 230 without substitution of the low resolution pattern fill. As can be seen by referring to square 285, it can be seen that the lines of the fill are very jagged.

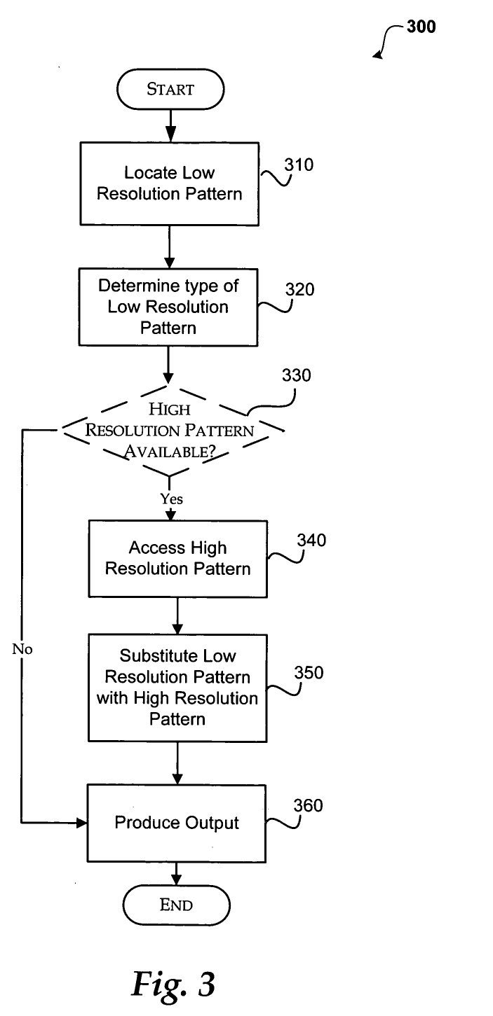

Referring now to FIG. 3, an illustrative process for substituting low resolution bitmaps will be described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

FIG. 3 illustrates a process for substituting low resolution patterns with high resolution patterns, in accordance with aspects of the invention.

After a start operation, the process flows to operation 310, where a low resolution pattern is located within a document. According to one embodiment, the low resolution pattern fills are bitmap patterns that are used to fill a shape. For example, a hatching bitmap may be used to fill a square, circle, or some other shape. Zero or more low resolution patterns may be located within a document.

At operation 320, the type of the low resolution pattern is determined. The type may refer to a particular pattern number, a name, and/or any other information that may be used to identify a specific low resolution pattern. For example, a pattern may be of type: Hatching Pattern 1; Horizontal Pattern 2; Vertical Pattern 3; and the like.

Moving to optional decision operation 330, a determination is made as to whether a high resolution pattern is available to substitute for the low resolution pattern. According to one embodiment, a high resolution pattern exists for every low resolution pattern that may be included within a document. This determination may be made in many different ways. For example, the determination may be made by comparing properties that are associated with each of the patterns, including comparing: names, patterns, styles, and the like.

When a high resolution pattern is not available for substitution, the process flows to operation 360 where the document is output using the low resolution pattern.

When a high resolution pattern is available, the process moves to operation 340 where the high resolution pattern is obtained that relates to the low resolution pattern. According to one embodiment, the high resolution pattern is accessed from a pattern data store.

Flowing to operation 350, the low resolution pattern is substituted with the high resolution pattern within the document.

Transitioning to operation 360, the output is produced. When a low resolution pattern has been substituted for a high resolution pattern, the output will typically appear to be of higher quality, and more close to the fill pattern as displayed on the device.

The process then moves to an end operation where the process returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for substituting a bitmap, comprising:
determining when a low resolution pattern exists within a document that is used to fill a shape;
accessing a high resolution pattern;
substituting the low resolution pattern with the high resolution pattern; and
producing an output that utilizes the high resolution pattern.

2. The computer-implemented method of claim 1, wherein the high resolution pattern is a resolution independent fill pattern.

3. The computer-implemented method of claim 2, wherein the output is a resolution independent document format.

4. The computer-implemented method of claim 2, wherein producing the output further comprises tiling the shape with the resolution independent fill pattern.

5. The computer-implemented method of claim 3, wherein determining when the low resolution pattern exists within the document that is used to fill the shape comprises accessing at least one record within a document representation that defines attributes for the shape.

6. The computer-implemented method of claim 1, wherein accessing the high resolution pattern comprises determining the high resolution pattern that corresponds to the low resolution pattern and obtaining the high resolution pattern from a data store.

7. The computer-implemented method of claim 6, wherein a resolution for each of the high resolution patterns that are located within the data store is approximately constant.

8. A computer-readable medium having computer-executable instructions for substituting a bitmap fill within a shape, comprising:
determining when a first bitmap is used to fill a shape;
accessing a second bitmap that contains a similar fill pattern as the first bitmap to substitute for the first bitmap; and
substituting the first bitmap with the second bitmap at a desired tile size.

9. The computer-readable medium of claim 8, wherein the second bitmap is a higher resolution bitmap as compared to the first bitmap.

10. The computer-readable medium of claim 8, further comprising producing an output; wherein the output is a resolution independent document format.

11. The computer-readable medium of claim 10 wherein the resolution independent document format is a Portable Document Format (PDF).

12. The computer-readable medium of claim 10, wherein substituting the first bitmap with the second bitmap comprises tiling the shape with the second bitmap at a fixed resolution-independent target tile size.

13. The computer-readable medium of claim 10, further comprising storing a second bitmap for each first bitmap that may be used within an application.

14. The computer-readable medium of claim 13, wherein a resolution for each of the second bitmaps is selected based on the output.

15. A system for substituting low resolution fills, comprising:
an application that is configured to:
create a document that includes at least one shape that includes a low resolution fill; wherein the low resolution fill may be selected from a set of low resolution fills;
produce a document representation that includes an attribute that describes the low resolution fill; and
output the document; and
a pattern manager that is coupled to the application and that is configured to perform actions, including:
accessing a high resolution fill; wherein the high resolution fill to access is determined in part from the attribute; and
instructing the application to substitute the low resolution fill with the high resolution fill.

16. The system of claim 15, wherein the application is further configured to output the document to a resolution independent document format.

17. The system of claim 16 wherein the resolution independent document format is a Portable Document Format (PDF).

18. The system of claim 17, wherein the application is further configured to tile the shape with the high resolution fill.

19. The system of claim 17, further comprising storing a high resolution fill for each of the low resolution fills.

20. The system of claim 17, wherein the pattern manager is included within the application.
